(19) United States
(12) Patent Application Publication
(10) Pub. No.: US 2017/0266684 A1
(43) Pub. Date: Sep. 21, 2017

(54) Paint shield for door jams

(71) Applicant: Bob L. Davis, Lakewood, CO (US)

(72) Inventor: Bob L. Davis, Lakewood, CO (US)

(21) Appl. No.: 15/075,143

(22) Filed: Mar. 19, 2016

(51) Int. Cl. B05B 15/04

(52) U.S. Cl. CPC B05B 15/0437

(57) ABSTRACT

A paint shield 10 for receipt on top of a doorway floor and between a first door jam and a second door jam. The paint shield includes a flat base sheet having one end with a first cutout center on one end and dimensioned to match a cross section of the bottom of the first door jam and engage the sides of the first door jam to prevent wet paint from spilling onto the floor next to the door jam. The paint shield also includes a sliding top sheet received on top of the flat base sheet. The top sheet has one end having as second cutout with a second cutout center on one end and dimensioned to match a cross second of the bottom of the second door jam.

This utility patent application claims the benefit of the filing date and subject matter found in a provisional patent application, Ser. No. 62/136,498, filed on Mar. 21, 2015, by the subject inventor.

### BACKGROUND OF THE INVENTION

(a) Field of the Invention

This invention relates to a wet paint protector for floor surfaces in a home or office, and more particularly, but not by way of limitation, to a wet paint shield used to protect floor surfaces next to a door jam, doorway or passage way and baseboards.

(b) Discussion of Prior Art

Heretofore, there have been a number of different types of wet paint shields, paint masking devices and drop cloths used to prevent spilling of paint on a floor surface. None of these prior art shields and devices having the unique features, objects and advantages of the subject invention as described herein.

### SUMMARY OF THE INVENTION

In view of the foregoing, it is a primary objective of the subject invention to protect a floor surface from wet paint next to a door jam, next to a doorway, and next to a baseboard.

Another object of the invention is the paint shield is adjustable in length for different widths of doorways, such as doorways having a width of 24, 30 or 36 inches. Also, the shield has sufficient width to extend past the doorway when painting a door trim casing. Further, the shield can be received under a closed door when painting the door or next to the door and painting next to a baseboard.

Still another object of the invention is a top sheet of the paint shield includes a 90 degree cutout for painting next to a right angle wall corner.

These and other objects of the present invention will become apparent to those familiar with different types of paint shields used to protect floor surfaces when reviewing the following detailed description, showing novel construction, combination, and elements as herein described, and more particularly defined by the claims, it being understood that changes in the embodiments to the herein disclosed invention are meant to be included as coming within the scope of the claims, except insofar as they may be precluded by the prior art.

### DESCRIPTION OF THE DRAWINGS

The accompanying drawings illustrate complete preferred embodiments in the present invention according to the best modes presently devised for the practical application of the subject wet paint shield, and in which:

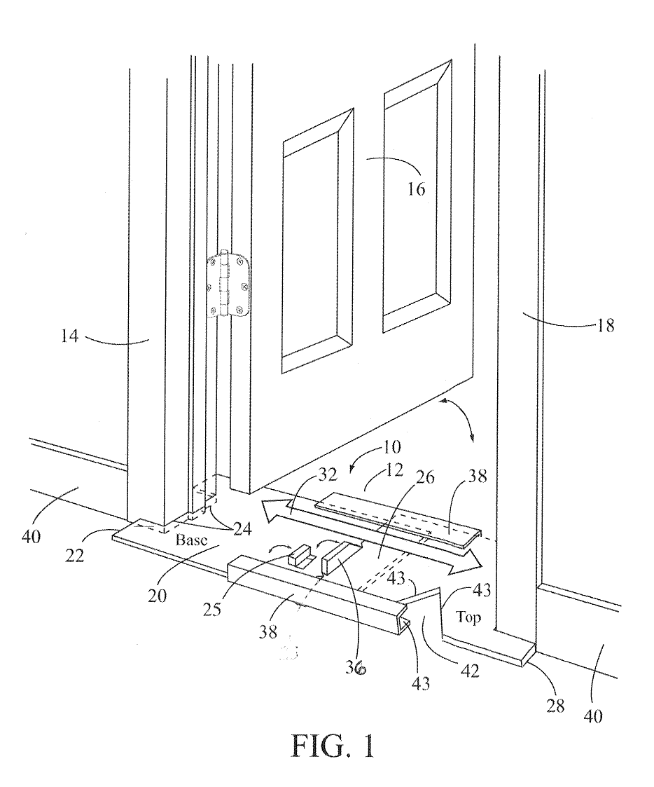

In FIG. 1, a perspective view of the subject wet paint shield is shown having general reference numeral 10. The paint shield 10 is shown disposed on top of a doorway 12 and between a first door jam 14, with a hinged door 16, mounted thereon and a second door jam 18. The paint shield 10 can be made of thin sheet plastic, laminated cardboard or a like material.

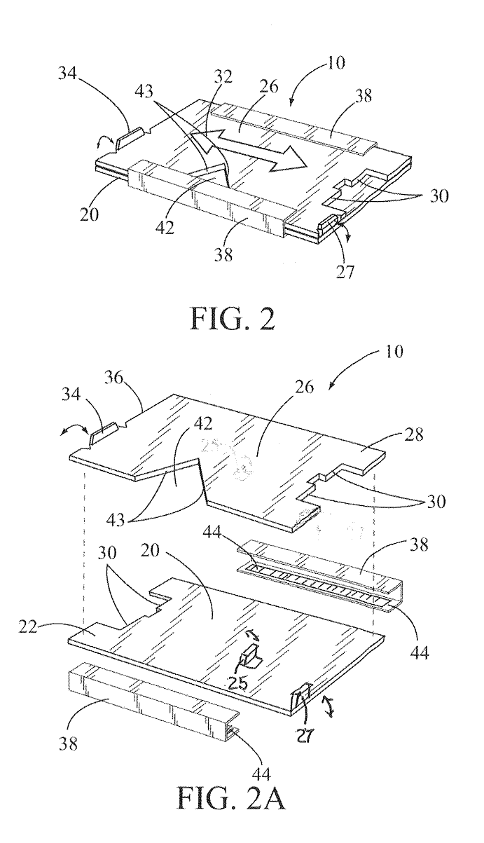

The paint shield 10 includes an angular-shaped flat base sheet 20 having one end 22 with a first cutout 24 center on the end and dimensioned to match a cross section of the bottom of the first door jam 14 and engage the sides of the first door jam to prevent wet paint from spilling onto the floor 12 next to the door jam. The base sheet 20 also includes a foldable stop 25 cut out of the base sheet 20 and a foldable handle 27, shown in FIG. 2A. The stop 25 is used to engage the sliding top sheet 26 when it is moved from right to left or from an extended position, for example when the paint shield is 36 inches in length, as shown in FIG. 1, to a semi-retracted position, for example when the paint shield is 30 inches in length. This feature allows the paint shield 10 to be disengaged from the first and second door jams 14 and 18 and move to another painting position next to baseboard in a room.

The paint shield 10 also includes an angular-shaped, sliding top sheet 26 received on top of the flat base sheet 20. The top sheet 26 has one end 28 having as second cutout 30 centered on one end and dimensioned to match a cross section of the second door jam 18. The cutout 30 can be seen more clearly in FIGS. 2, 2A and 4. In this drawing, the top sheet 24 is shown moving from left to right, as indicated by arrow 32, for the cutout 30 to engage a bottom of the door jam 18. The top sheet 26 also includes a foldable handle 34 on an opposite end 36 of the top sheet 24 for moving it back and forth on top of the base sheet 20 and adjusting a length, in a range of 24, 30, 36 inches, of the paint shield to different widths of doorways between the door jams. The paint shield has a typical width of 24 inches or greater. The top sheet 26 is held on top of the base sheet 20 for sliding thereon using a pair of “J” shaped or “U” shaped tracks 38.

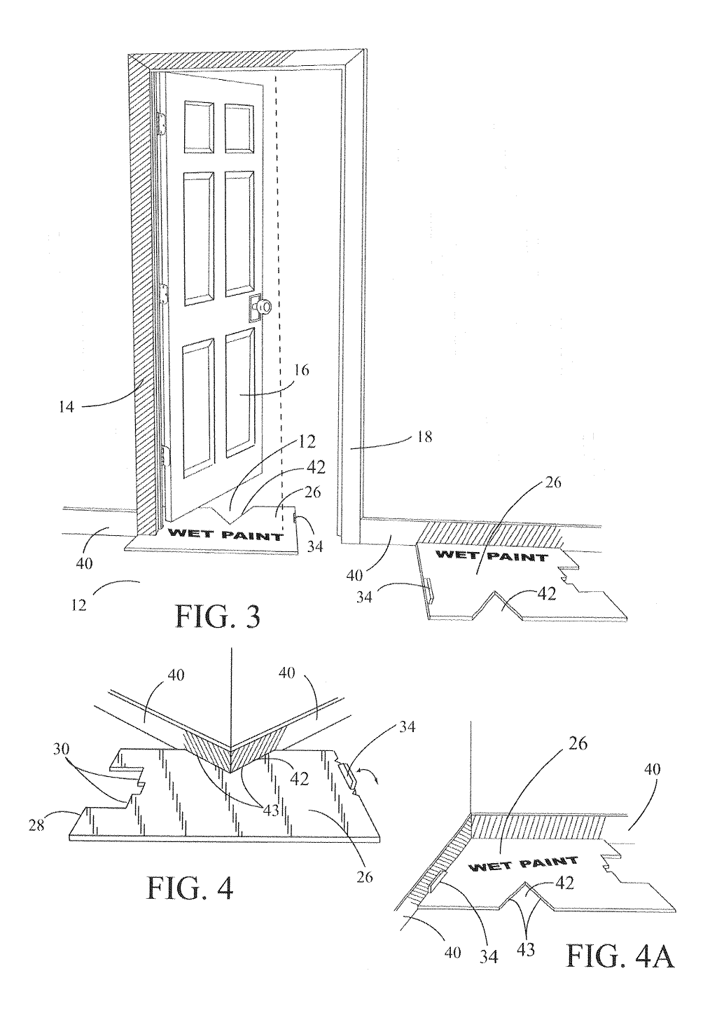

In FIG. 2, a perspective view of the wet paint shield 10 is shown with the top sheet 26 disposed on top of the base sheet 20 and in a retracted position. It should be noted, the top sheet 26, when removed from the base sheet 20, can be used for placing a side of the sheet against a base board 40 and preventing paint for contacting a floor next to the base board, as shown in FIGS. 3, 4 and 5. The top sheet 26 also includes a 90 degree or right angle notch 42 having sides 43, shown in FIG. 2A, for engaging baseboard sides at a 90 degree corner wall. When the handles 27 and 34 are folded upwardly as shown in this drawing, the top sheet 26 is held in place on top of the base sheet 20 for use in painting other areas of a room or when transporting the paint shield 10 from one location to the next.

In FIG. 2A, an exploded view of the paint shield 10 is shown with the top sheet 26 disposed above the base sheet 20. In this drawing, the “J” shaped tracks 38 are shown removed from opposite sides of the base sheet 20 and the top sheet 26. A lower side of the tracks 38 include an adhesive tape 44 thereon for securing the tracks to a bottom portion of the base sheet 20.

In FIG. 3, the top sheet 26 has been removed from the base sheet 20 with the cut out 30 engaging the bottom of the first door jam 14 for protecting the floor surface next to the door jam 14 from wet paint. Also in the drawing, a side of the top sheet is shown next to a portion of the baseboard 40.

In FIG. 4, sides 43 of the 90 degree notch 42 in the top sheet 26 are shown received against the baseboard 40. The baseboard is part of a 90 degree exterior wall corner. In this example, the top sheet is used to protect the floor next to the exterior wall corner from wet paint.

In FIG. 5, a 90 degree corner of the top sheet 26 is received against the baseboard 40 with a 90 degree interior corner. In this example, the top sheet is used to protect the floor next to an interior corner from wet paint.

While the invention has been particularly shown, described and illustrated in detail with reference to the preferred embodiments and modifications thereof, it should be understood by those skilled in the art that equivalent changes in form and detail may be made therein without departing from the true spirit and scope of the invention as claimed except as precluded by the prior art.

The embodiments of the invention for which an exclusive privilege and property right is claimed are defined as follows:

1. A paint shield for protecting a floor surface between and next to a first door jam and a second door jam from wet paint when painting the door jams, the paint shield comprising:
a flat base sheet having one end with a first cutout centered thereon, the first cutout dimensioned to match a cross section of the first door jam; the first cutout adapted for engaging a bottom of the first door jam;
a sliding top sheet received on top of the base sheet, the top sheet having one end with a second cutout centered thereon, the second cutout dimensioned to match a cross section of the second door jam, the second cutout adapted for engaging a bottom of the second door jam; and
means for securing sides of the flat base sheet next to sides of the sliding top sheet and allowing the top sheet to slide outwardly from the base sheet into a extended position and slide inwardly into a retracted position.

2. The paint shield as described in claim 1 wherein the means for securing is a pair of “J” shaped or “U” shaped tracks, the tracks received around a portion of opposite sides of the base sheet and the top sheet.

3. The paint shield as described in claim 1 wherein an opposite end of the sliding top sheet includes a foldable handle, the handle used for moving the top sheet on top of the flat base sheet.

4. The paint shield as described in claim 1 wherein a side of the sliding top sheet includes a 90 degree notch therein, sides of the 90 degree notch adapted for engaging baseboard on an exterior wall corner.

5. The paint shield as described in claim 1 wherein an opposite end of the flat base sheet includes a foldable handle, the foldable handle used for moving the flat base sheet on the sliding top sheet.

6. The paint shield as described in claim 1 wherein the flat base sheet includes a foldable stop thereon, the stop used for holding the sliding top sheet in place when retracted on top of the base sheet.

7. A paint shield used for protecting a floor surface between and next to a first door jam and a second door jam from wet paint when painting the door jams, the paint shield comprising:
an angular-shaped flat base sheet having one end with a first cutout centered thereon, the first cutout dimensioned to match a cross section of the first door jam; the first cutout adapted for engaging a bottom of the first door jam;
an angular-shaped sliding top sheet received on top of the base sheet, the top sheet having one end with a second cutout centered thereon, the second cutout dimensioned to match a cross section of the second door jam, the second cutout adapted for engaging a bottom of the second door jam; and
a pair of “J” shaped tracks, the tracks disposed on opposite sides of the base sheet and the top sheet and releasably attached thereto, the tracks allowing the top sheet to slide outwardly from the base sheet into a extended position and slide inwardly into a retracted position.

8. The paint shield as described in claim 7 wherein the tracks include an adhesive tape used for attaching the tracks to a portion of the opposite sides of the flat base sheet.

9. The paint shield as described in claim 7 wherein the sliding top sheet and flat base sheet are made of thin sheet plastic, or laminated cardboard or the like.

10. The paint shield as described in claim 7 wherein an opposite end of the sliding top sheet includes a foldable handle, the handle used for moving the top sheet on top of the flat base sheet.

11. The paint shield as described in claim 7 wherein a side of the sliding top sheet includes a 90 degree notch therein, sides of the 90 degree notch adapted for engaging baseboard on an exterior wall corner.

12. The paint shield as described in claim 7 wherein an opposite end of the flat base sheet includes a foldable handle, the foldable handle used for moving the flat base sheet on the sliding top sheet.

13. The paint shield as described in claim 7 wherein the flat base sheet includes a foldable stop thereon, the stop used for holding the sliding top sheet when retracted on top of the base sheet.

14. A paint shield used for protecting a floor surface between and next to a first door jam and a second door jam from wet paint when painting the door jams, the paint shield comprising:
an angular-shaped flat base sheet having one end with a first cutout centered thereon, the first cutout dimensioned to match a cross section of the first door jam; the first cutout adapted for engaging a bottom of the first door jam, an opposite end of the base sheet including a foldable handle;
an angular-shaped sliding top sheet received on top of the base sheet, the top sheet having one end with a second cutout centered thereon, the second cutout dimensioned to match a cross section of the second door jam, the second cutout adapted for engaging a bottom of the second door jam, an opposite end of the sliding top sheet including a foldable handle; and
a pair of “J” shaped or “U” shaped tracks, the tracks disposed on opposite sides of the base sheet and the top sheet and releasably attached thereto, the tracks allowing the top sheet to slide outwardly from the base sheet into a extended position and slide inwardly into a retracted position.

15. The paint shield as described in claim 14 wherein the base sheet and the top sheet have a width of 24 inches and a length of 24 inches.

16. The paint shield as described in claim 15 wherein when the sliding top sheet is extended outwardly from the base sheet, the length of the paint shield is up to 36 inches.

17. The paint shield as described in claim 14 wherein the tracks include an adhesive tape used for attaching the tracks to a portion of the opposite sides of the flat base sheet.

18. The paint shield as described in claim 14 wherein a side of the sliding top sheet includes a 90 degree notch therein, sides of the 90 degree notch adapted for engaging baseboard on an exterior wall corner.
